(19) United States
(12) Patent Application Publication
(10) Pub. No.: US 2009/0006189 A1
(43) Pub. Date: Jan. 1, 2009

(54) DISPLAYING OF ADVERTISEMENT-INFUSED THUMBNAILS OF IMAGES

(75) Inventors: Lei Zhang, Beijing (CN); Wei-Ying Ma, Beijing (CN); Ruochi Zhang, Beijing (CN); Zhiwei Li, Beijing (CN); Hsiao-Wuen Hon, Bellevue, WA (US); Heung-Yeung Shum, Bellevue, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/769,518

(22) Filed: Jun. 27, 2007

(51) Int. Cl. G06Q 30/00

(52) U.S. Cl. 705/14

(57) ABSTRACT

An image advertisement system of a computing device displays as part of a display page an advertisement-infused thumbnail of an image prior to displaying the image. The image advertisement system initially receives a display page with an indication of an image to be displayed as part of the display page. The image advertisement system generates an advertisement-infused thumbnail of the image by combining advertisement content with a thumbnail of the image. The image advertisement system then displays the display page with the advertisement-infused thumbnail of the image in place of the image. The image advertisement system then replaces the displayed advertisement-infused thumbnail with the image.

### BACKGROUND

Many web sites provide their services free to users, but may derive significant revenue from advertisements presented to the users. These advertisements are typically either a sponsored link that is inserted into a web page or advertisement content that is displayed as part of a web page. Advertisements included in a web page typically comprise text (and possibly a graphic) and a hyperlink to a web page that provides more information about what is being advertised. For example, if a product is being advertised, the hyperlink may point to a web page through which the product may be purchased. When a user selects the advertisement, the web page to which the hyperlink points is retrieved and then displayed to the user. Advertisers compensate web site providers based on either placement of each advertisement on a web page that is served to a user (i.e., cost per impression) or selection of the advertisement by the user resulting in accessing of the pointed to web page (i.e., cost per click).

Many web sites rely on an advertisement server for providing advertisements to be included on web pages of the web site. When a web site serves a web page to a user, the web page may include advertisement links to the advertisement server at various locations on the web page where advertisements are to be displayed. When the user's computing device receives the web page, it resolves each advertisement link by sending a request to the advertisement server. Upon receiving the request, the advertisement server selects an advertisement that is appropriate to the web page and responds to the request by providing the content of the advertisement to the user's computing device. Upon receiving the content, the user's computing device displays the advertisement at a designated location on the web page. Advertisement services that provide advertisement servers typically charge the advertisers based on a cost per impression or cost per click. An advertisement service typically splits the fee it collects from an advertiser for placing an advertisement with the web site provider that served the web page. Thus, both the advertisement service and the web site provider benefit from placement of the advertisement.

Advertisement servers typically have a database of advertisements along with placement attributes. The placement attributes may specify the characteristics of target web pages with which the advertisement is to be placed. For example, the placement attributes may specify the topic of the target web page (e.g., kayaks), keywords of the content of the target web page, demographics of the user to whom the web page is displayed (e.g., male under 24 years old), and so on. When an advertisement link is resolved as a web page is being displayed, a request is first sent to an advertisement server. The request may include some characteristics of the web page. Upon receiving the request, the advertisement server selects an advertisement based in part on how well the placement attributes match the characteristics of the web page. The advertisement server then responds to the request by sending the selected advertisement, which is then displayed as part of the web page.

Many types of web sites provide images as part of the content of their web pages. For example, a vendor's web page may include a photograph of a product being sold by the vendor, a news web page may include a photograph of the person who is the topic of the web page, an astronomy web page may include a photograph of a distant galaxy, a medical web page may include a scan of a patient's brain, and so on. Some web sites are dedicated to providing images. For example, image search engines allow users to search for images of interests that are published on any web page that is accessible by crawling the web or that are stored in certain image collection databases. To search for images, a user typically submits a search request (e.g., “daffodils”) to the image search engine. The search engine upon receiving the request identifies images that may be related to the request (e.g., photographs of daffodils) as the search results. The search engine service then sends to the user's computing device a web page that may include a thumbnail of each identified image of the search results and a link to a full-resolution version of the image. The web page is then presented to the user as the search results. When the user selects a thumbnail of an image, a full-resolution version is retrieved and then displayed to the user. Another example of a web site dedicated to providing images is a photograph sharing community. A photograph sharing web site allows users to upload their personal photographs, which can then be shared with other users of the web site. A user can search for photographs of interest that have been uploaded, and the results may be presented in a way that is similar to how results of an image search engine are presented. The search results are typically presented as thumbnails because a full-resolution version of an image may be very large (e.g., several megabytes) and may take several seconds to download the image. If the search results web page actually displays many full-resolution images, it might take many 10s of seconds to download the images for the web page—so thumbnails of the images are displayed. Even so, since it can take several seconds to download an image, a user may experience a delay of several seconds from the time a thumbnail is selected to when the corresponding full-resolution image is displayed.

The potential revenue of a web site provider is controlled, in part, by the amount of space of its web pages that is dedicated to advertisements. If a web page contains too much advertisement space, then there may be too little substantive content for the web page to be of interest to users. If a web page is not of interest to users, then users will not visit the web page and the web page provider will not generate advertising revenue. Conversely, if the web page contains too little advertisement space, the web site provider may be forgoing potential revenue resulting from the additional advertisements that could have been placed if the web page had more advertising space.

### SUMMARY

The displaying of advertisements in place of an image of a display page prior to the display of the image is provided. An image advertisement system of a computing device displays as part of a display page an advertisement-infused thumbnail of an image prior to displaying the image. The image advertisement system initially receives a display page with an indication of an image to be displayed as part of the display page. The image advertisement system generates an advertisement-infused thumbnail of the image by combining advertisement content with a thumbnail of the image. The image advertisement system then displays the display page with the advertisement-infused thumbnail of the image in place of the image. The image advertisement system then replaces the displayed advertisement-infused thumbnail with the image.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagram of a web page that illustrates an advertisement-infused thumbnail.

FIG. 2 is a diagram of a web page that illustrates a full-version resolution of an image replacing an advertisement-infused thumbnail.

FIG. 3 is a diagram of a web page that illustrates a full-resolution version of an image replacing an advertisement-infused thumbnail on a section-by-section basis.

FIG. 4 is a block diagram that illustrates components of the image advertisement system in one embodiment.

FIG. 5 is a flow diagram that illustrates the logical processing of a display image at once component of the image advertisement system in some embodiments.

FIG. 6 is a flow diagram that illustrates the logical processing of a display image by fading component of the image advertisement system in some embodiments.

FIG. 7 is a flow diagram that illustrates the logical processing of a display advertising options component of the image advertisement system in one embodiment.

### DETAILED DESCRIPTION

The displaying of advertisements in place of an image of a display page prior to the display of the image is provided. In some embodiments, an image advertisement system takes advantage of the delay in downloading images of display pages, such as web pages, by displaying advertisements in place of the images while the images are being downloaded. After an image is downloaded, the image advertisement system then replaces the advertisement with the image. While the advertisement is displayed, the image advertisement system may activate a hyperlink to a web page of the advertiser. Thus, if a user selects the advertisement, the user is directed to a web page of the advertiser. When the image is displayed, the image advertisement system activates any hyperlink that would normally be associated with the image. In this way, the image advertisement system effectively increases the advertisement space of a web page by using a non-advertisement space of images before the images are displayed.

In some embodiments, the image advertisement system generates the advertisement from a thumbnail of the image and advertisement content. The image advertisement system may provide the thumbnail of the image to the user's computing device in various ways. The thumbnail of the image may be embedded in the web page in which the image is to be displayed, may be saved when a user selects the thumbnail of image search results, may be downloaded from an image server based on a thumbnail hyperlink included in the web page, and so on. The image advertisement system may retrieve the advertisement content (e.g., advertisement text, text and logo, animation, sound, and so on) from an advertisement server in much the same way as conventional advertisements are retrieved from an advertisement server. To generate the advertisement, the image advertisement system may enlarge the thumbnail based on the size of the image. For example, it may enlarge the thumbnail to the full image size, a certain percentage of the image size, and so on. Since an enlarged thumbnail will have a fairly low resolution, the image advertisement system may blur the enlarged thumbnail so that the user perceives a blurred version of the image rather than simply a low resolution of the image. The image advertisement system then infuses the advertisement content into the enlarged thumbnail, for example, by statically superimposing advertisement text onto the enlarged thumbnail. The image advertising system then displays this “advertisement-infused thumbnail.” The image advertisement system may also dynamically infuse advertisement content into an enlarged thumbnail as it is displayed. The advertisement content may represent an animation that is superimposed on an enlarged thumbnail. For example, the animation may show text scrolling across the enlarged thumbnail, may show an animated avatar of a spokesman for the advertiser within the enlarged thumbnail, may show objects (e.g., currency symbols or an advertiser's logo) moving about the enlarged thumbnail, and so on.

In some embodiments, the image advertisement system may use various advertisement termination criteria in determining when to replace the advertisement with the image. One advertisement termination criterion may be upon completion of the download of the full-resolution image. Another advertisement termination criterion may be after the full-resolution image is available and after the advertisement has been displayed for a minimum display time. For example, if the full-resolution version of the image becomes quickly available in 1 second and the minimum display time is a longer 3 seconds, then the image advertisement system would not replace the advertisement until after it has been displayed for 3 seconds. The minimum display time helps ensure that an advertisement is not displayed and then immediately replaced by the image in a way that is distracting to the user or does not give the user sufficient opportunity to select the advertisement.

In some embodiments, the image advertisement system may use a transition technique to replace the advertisement with the image. As described above, the image advertisement system may simply replace the advertisement with the entire image at once. In addition, the image advertisement system may gradually fade out the advertisement and fade in the image. Such fading may be particularly useful when the full-resolution version of the image is downloaded by downloading an initial low-resolution version of the image followed by downloading of pixel information for increasingly higher resolutions of the image. For example, the downloading may start with the downloading of every 16th pixel of the image as the low-resolution version, followed by the downloading of every fourth pixel not previously downloaded, followed by the downloading of every second pixel not previously downloaded, and followed by the downloading of every pixel not previously downloaded. The image advertisement system may also gradually replace the advertisement with the image on a section-by-section basis. For example, the image advertisement system may receive the pixels of the image on a row-by-row basis. In such a case, the image advertisement system may simply overwrite the advertisement with each row or groups of rows as they are received. If the advertisement content is displayed toward the bottom of the advertisement, then the advertisement content will not be replaced until virtually the entire image is downloaded. The image advertisement system may use timing criteria to ensure that the fading in and the section-by-section replacement occur at an appropriate speed.

In some embodiments, the image advertisement system may automatically generate the characteristics of the image or the web page for locating an appropriate advertisement. The image advertisement system may extract keywords from text that surrounds the image, may retrieve demographic information about the user, may extract text from the link (e.g., URL) to the image, and so on to use as characteristics. In addition, providers of web pages may provide metadata in the web page specifying the characteristics for selection of an appropriate advertisement. The suppliers of images may also provide metadata specifying the characteristics for selection of an appropriate advertisement. For example, when an image search engine generates search results, it may include the metadata provided by the supplier of the image in the web page of the search results. In such a case, when a user selects a thumbnail of the research results, the image advertisement system can submit a request to an advertisement server based on the metadata provided by the supplier of the image.

In some embodiments, the image advertisement system may allow a user to a replay an advertisement. This may be useful, for example, when a user notices an advertisement and wants to visit the advertiser's web site, but the image replaces the advertisement before the user can select the advertisement. The image advertisement system may display various advertising-related options when a user takes a certain action, such as hovering a mouse pointer over the image or right clicking on the image. When the user takes such an action, the image advertisement system may replace the image with the advertisement and then eventually replace the advertisement with the image in a manner similar to how the image initially replaced the advertisement. This re-display of the advertisement provides the user with the opportunity to select the advertisement. In addition, the image advertisement system may display options such as to replay the advertisement and to visit the advertiser's web page. The user can then select the desired option.

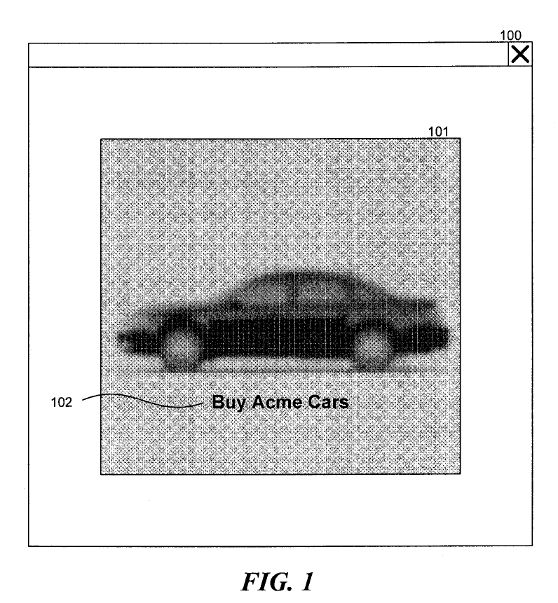

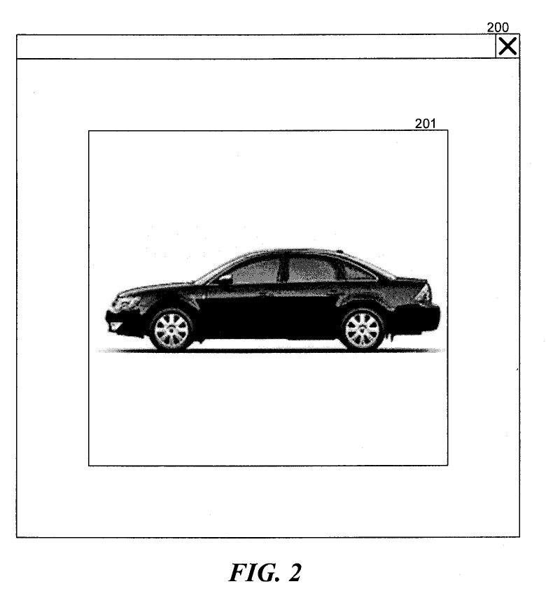

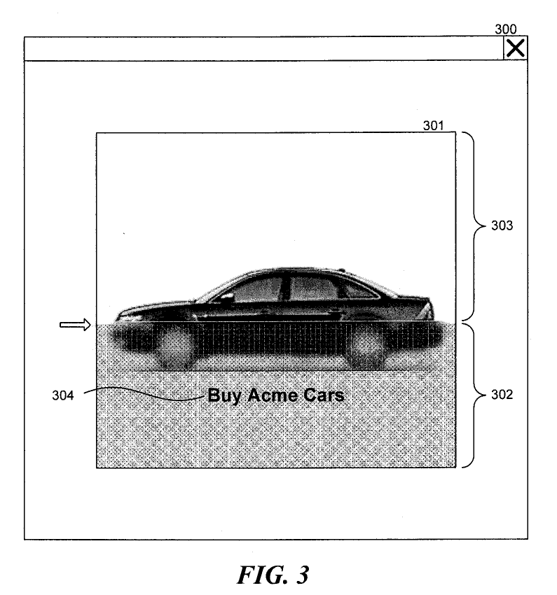

FIG. 1 is a diagram of a web page that illustrates an advertisement-infused thumbnail. A web page 100 includes an advertisement-infused thumbnail 101 being displayed in place of the full-resolution version of the image. The image may be of an automobile. To generate the advertisement-infused thumbnail, the image advertisement system enlarged the thumbnail to the full size of the image. The image advertisement system then blurred the image as indicated by the shading of the thumbnail. The image advertisement system then superimposed the advertising text 102, “Buy Acme Cars,” over the enlarged and blurred thumbnail. If the user selects the advertisement-infused thumbnail, then the image advertisement system may direct that the advertiser's web page be retrieved and displayed. FIG. 2 is a diagram of a web page that illustrates a full-version resolution of an image replacing an advertisement-infused thumbnail. A web page 200 includes a full-resolution version of an image 201 that replaced the advertisement-infused thumbnail 101. FIG. 3 is a diagram of a web page that illustrates a full-resolution version of an image replacing an advertisement-infused thumbnail on a section-by-section basis. The web page 300 includes an image display space 301. The image display space originally displayed the entire advertisement-infused thumbnail 101. As the full-resolution version of the image was received on a row-by-row basis, the image advertisement system replaced the top of the advertisement-infused thumbnail with the top of the image where a section comprises one or more rows. As illustrated, a portion 303 represents a portion of the full-resolution version, and a portion 302 represents a portion of the advertisement-infused thumbnail. In this example, because an advertisement content 304 was superimposed at the lower part of the thumbnail, the advertisement content continues to be displayed until almost all the rows of the image are downloaded.

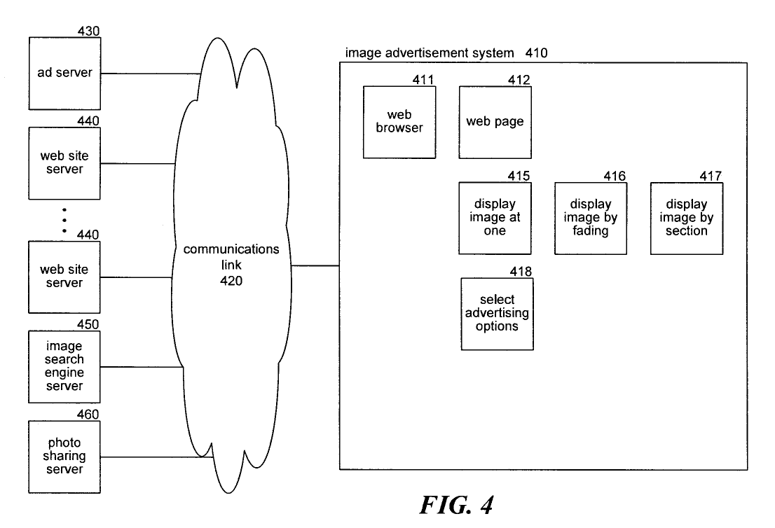

FIG. 4 is a block diagram that illustrates components of an image advertisement system in one embodiment. The image advertisement system 410 may be implemented on a user's computing device that is connected to an advertisement server 430, various web site servers 440, an image search engine server 450, and a photograph sharing server 460 a via communications link 420. The image advertisement system includes components that can be downloaded to a user's computing device as part of the download of a web page or independently of the download of any web page. The image advertisement system interacts with a web browser 401 that displays a web page 412 that may be downloaded from a web site server, an image search engine server, a photograph sharing server, and so on. The image advertisement system may include various components for displaying an advertisement-infused image using various transition techniques. The image advertisement system may include a display image at once component 415, a display image by fading component 416, and a display image by section component 417. The display image at once component displays an advertisement-infused thumbnail and then simply writes over the advertisement-infused thumbnail after the image is received. The display image by fading component replaces an advertisement-infused thumbnail by fading out the advertisement-infused thumbnail and fading in the full-resolution version of the image over time. The display image by section component replaces the advertisement-infused thumbnail by overwriting it with the full-resolution version of the image on a section-by-section basis. The image advertisement system also includes a select advertising options component 418 that allows the user an opportunity to view the advertisement or visit the advertiser's web site after the advertisement-infused thumbnail has been replaced.

The computing device on which the image advertisement system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the instructions, data structures, and message structures may be stored or transmitted via a data transmission medium, such as a signal on a communications link. Various communications links may be used, such as the Internet, a local area network, a wide area network, a point-to-point dial-up connection, a cell phone network, and so on.

Embodiments of the image advertisement system may be implemented and used in conjunction with various operating environments that include personal computers, server computers, hand-held or laptop devices, multiprocessor systems, microprocessor-based systems, programmable consumer electronics, digital cameras, network PCs, minicomputers, mainframe computers, cell phones, personal digital assistants, smart phones, personal computers, programmable consumer electronics, distributed computing environments that include any of the above systems or devices, and so on.

The image advertisement system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

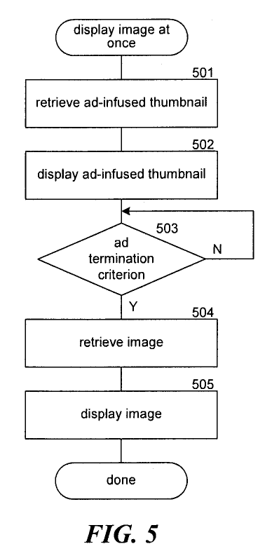

FIG. 5 is a flow diagram that illustrates the logical processing of a display image at once component of the image advertisement system in some embodiments. The component displays an advertisement-infused thumbnail until an advertisement termination criterion is satisfied and then replaces it with the image. The component may be downloaded to a user's computing device as script or other code of a downloaded web page. In block 501, the component retrieves an advertisement-infused thumbnail. The advertisement-infused thumbnail may be generated at the user's computing device as described above. The thumbnail and/or the advertisement content may be downloaded with the web page; the thumbnail may be downloaded with a previously retrieved web page (e.g., image search results); the advertisement content may be downloaded from an advertisement server; and so on. In block 502, the component displays the advertisement-infused thumbnail. In decision block 503, the component waits until an advertisement termination criterion has not been satisfied such as the advertisement-infused thumbnail has been displayed for a minimum display time. When the advertisement termination criterion is satisfied, the component continues at block 504. In block 504, the component retrieves the image, which may have been downloaded from an image server while the advertisement-infused thumbnail was displayed. In block 505, the component displays the image and then completes.

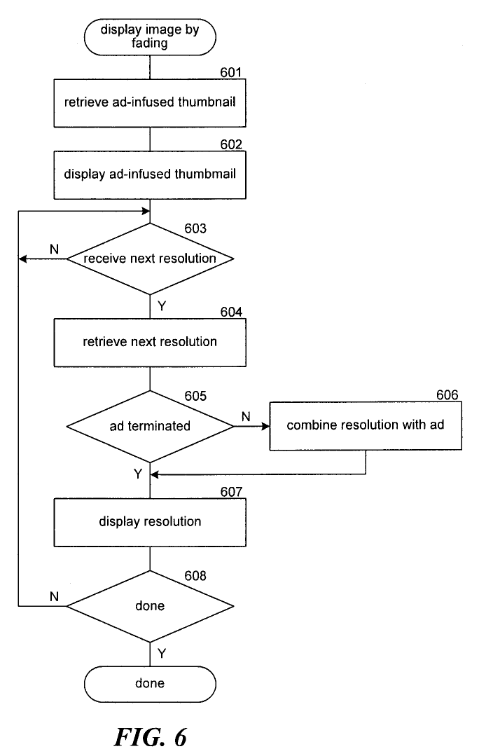

FIG. 6 is a flow diagram that illustrates the logical processing of a display image by fading component of the image advertisement system in some embodiments. The component displays an advertisement-infused thumbnail and then fades it out by fading in increasingly higher resolutions of the image. In block 601, the component retrieves the advertisement-infused thumbnail. In block 602, the component displays the advertisement-infused thumbnail. In blocks 603-608, the component loops progressively displaying higher-resolution versions of the image to effect the fading in of the image and the fading out of the advertisement-infused thumbnail. In decision block 603, the component waits until the pixels for the next higher resolution version are received. When they are received, the component continues at block 604. In block 604, the component retrieves the pixels for the next resolution. In decision block 605, if an advertisement termination criterion is satisfied, then the component continues at block 607, else the component continues at block 606. The advertisement termination criterion may indicate to perform a complete fade-out of the advertisement-infused thumbnail when a certain resolution version has been received. In block 606, the component combines the pixels of the next resolution with the advertisement-infused thumbnail. In block 607, the component displays either the combined image of block 606 or the image by itself in the current resolution. In decision block 608, if the full-resolution image has been displayed, then the component completes, else the component loops to block 603 to retrieve the next resolution of the image. Although not illustrated by a separate figure, the display image by section component works in a similar manner, except downloading the image on a section-by-section basis rather than a resolution-by-resolution basis.

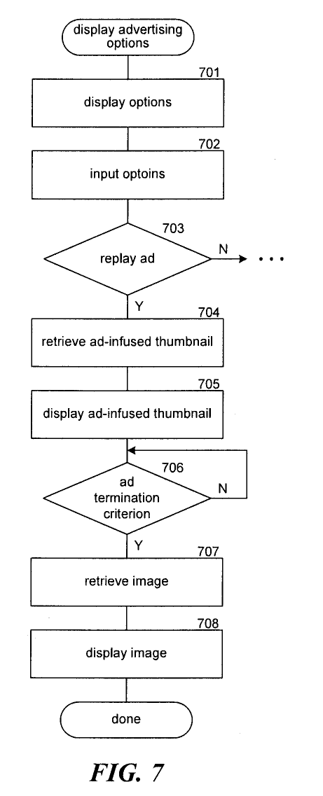

FIG. 7 is a flow diagram that illustrates the logical processing of a display advertising options component of the image advertisement system in one embodiment. The component may be invoked when a user hovers a mouse pointer over the image. The component provides the opportunity for the user to re-display the advertisement-infused thumbnail or visit the advertiser's page. In block 701, the component displays the advertising options, for example, in a pop-up window over the image. In block 702, the component inputs an option selection from a user. In decision block 703, if the option selection is to replay the advertisement, then the component continues at block 704, else the component processes another option selection, such as visiting a web page of the advertiser. In block 704, the component retrieves the advertising-infused thumbnail that was previously generated. In block 705, the component displays the advertisement-infused thumbnail. In block 706, the component waits until an advertisement termination criterion is satisfied, such as the advertisement-infused thumbnail is displayed for a certain time. Different advertisement termination criteria may be used for the initial display and the re-display of an advertisement. When the advertisement termination criterion is satisfied, the component continues at block 707. In block 707, the component retrieves the image. In block 708, the component displays the image and then completes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, an “advertisement-infused image” may be displayed while frames of a video are being downloaded. The equivalent of an “enlarged thumbnail” may be a frame from the first part of the video. The advertisement content can then be infused into that frame and displayed until the video starts being displayed. Also, one skilled in the art will appreciate that the full-resolution version of the image refers to the resolution of the image that is downloaded to the computing device or the resolution that can be displayed. The actual resolution of the image as, for example, stored on an image server may be higher. In addition, the image advertisement system may be adapted so that selection of the advertisements may be tracked and revenue can be provided to the provider of the web page and/or supplier of the image. Accordingly, the invention is not limited except as by the appended claims.

I/We claim:

1. A method in a computing device for displaying an advertisement, the method comprising:
receiving a display page with an indication of an image to be displayed as part of the display page;
displaying the display page with an advertisement-infused thumbnail of the image in place of the image; and
replacing the displayed advertisement-infused thumbnail with the image.

2. The method of claim 1 wherein the advertisement-infused thumbnail of the image is displayed while the image is being downloaded to the computing device.

3. The method of claim 1 wherein a thumbnail of the image is included with the display page, the advertisement is retrieved for an advertisement server, and the thumbnail is infused with the advertisement at the computing device.

4. The method of claim 1 including when a user selects the advertisement-infused thumbnail, displaying a display page associated with the advertisement.

5. The method of claim 1 wherein the thumbnail is blurred.

6. The method of claim 1 wherein the thumbnail is enlarged based on the size of the image.

7. The method of claim 1 wherein the replacing of the advertisement-infused thumbnail includes fading out of the advertisement-infused thumbnail and fading in of the image.

8. The method of claim 1 wherein the replacing of the advertisement-infused thumbnail includes displaying the image on a section-by-section basis.

9. The method of claim 1 including while the image is displayed, receiving an indication to display the advertisement and replacing the displayed image with the advertisement-infused thumbnail.

10. A computer-readable medium containing instructions for controlling a computing device to display an advertisement, by a method comprising:
receiving a web page with a reference of an image to be displayed as part of the web page;
requesting the image identified by the reference to be downloaded to the computing device;
receiving an advertisement from an advertisement server;
enlarging the thumbnail based on the size of the image;
displaying the web page with the enlarged thumbnail along with the advertisement in place of the image; and
replacing the displayed enlarged thumbnail along with the advertisement with the image.

11. The computer-readable medium of claim 10 including when a user selects the displayed thumbnail, displaying a web page associated with the advertisement.

12. The computer-readable medium of claim 10 including blurring the thumbnail.

13. The computer-readable medium of claim 10 wherein the replacing of the displayed enlarged thumbnail along with the advertisement includes fading out of the enlarged thumbnail along with the advertisement and fading in of the image.

14. The computer-readable medium of claim 10 wherein the replacing of the enlarged thumbnail along with the advertisement includes displaying a full-resolution version of the image on a section-by-section basis.

15. The computer-readable medium of claim 10 including while the image is displayed, receiving an indication to display the advertisement and replacing the displayed image with the enlarged image along with the advertisement.

16. The computer-readable medium of claim 10 including tracking the selection of the advertisement so that revenue resulting from the selection can be shared between the provider of the web page and the provider of the image.

17. The computer-readable medium of claim 10 wherein the advertisement is animation superimposed on the displayed thumbnail.

18. A computing device for displaying an advertisement, comprising:
a display page store with a reference to an image to be displayed as part of the display page;
a component that retrieves the referenced image;
a component that retrieves an advertisement;
a component that infuses a thumbnail of the image to generate an advertisement-infused thumbnail;
a component that displays the display page with an advertisement-infused thumbnail of the image in place of the image; and
a component that replaces the displayed advertisement-infused thumbnail with the image.

19. The computing device of claim 17 wherein the thumbnail is received via a display page that was previously displayed.

20. The computing device of claim 17 including a component to re-display the advertisement-infused image when requested by a user.
